(19) United States
(12) Patent Application Publication
(10) Pub. No.: US 2025/0348241 A1
(43) Pub. Date: Nov. 13, 2025

(54) STORAGE DEVICE AND CONTROL METHOD THEREOF

(71) Applicant: Hitachi Vantara, Ltd., Yokohama-shi (JP)

(72) Inventors: Masaya MIURA, Tokyo (JP); Akihito MIYAZAWA, Tokyo (JP); Masakazu KOBAYASHI, Tokyo (JP)

(21) Appl. No.: 19/073,192

(22) Filed: Mar. 7, 2025

(30) Foreign Application Priority Data
May 13, 2024 (JP) 2024-078272

(51) Int. Cl. G06F 3/06

(52) U.S. Cl. CPC G06F 3/0632; G06F 3/0604; G06F 3/067

(57) ABSTRACT

A hash value recording database records a hash value of common data of each of resources, and an information acquisition efficiency improving service refers to the hash values of the common data recorded in the hash value recording database, groups a plurality of target resources from which configuration information is to be acquired into groups each having the same hash value of the common data, acquires common data of each of the groups, and acquires dynamic data of each of the resources.

### CROSS-REFERENCE TO RELATED APPLICATION

The present application claims priority from Japanese application JP2024-078272, filed on May 13, 2024, the content of which is hereby incorporated by reference into this application.

### BACKGROUND OF THE INVENTION

### 1. Field of the Invention

The present invention relates to a storage device and a control method thereof.

### 2. Description of Related Art

In recent years, a storage is operated in a cloud, and a configuration management process of the storage is frequently performed in response to a user's request even during an operation of a system, and thus improvement in response performance to a configuration information acquisition request is required.

Since the storage has many configuration resources, a CPU and a memory of the storage are often used to acquire configuration information and create a response. Since the number of simultaneously executable APIs by a storage is limited due to restrictions of the CPU and the memory, an efficient configuration information acquisition process is required to improve the response performance to the configuration information acquisition request.

When an API server that acquires the configuration information of the storage acquires the configuration information of the plurality of resources, the API server acquires all the data of all the resources even if there is common data in the configuration information of each resource, and holds the acquired data in the memory until the response is created. Therefore, an amount of data held in the memory increases, the number of simultaneously executable APIs is limited, and the response performance of the configuration information acquisition decreases. In addition, when the amount of data held in the memory increases, area management including allocation and releasing of the memory is required, and thus the response performance of the configuration information acquisition is further deteriorated.

Further, the number of data conversion processes executed by the CPU for response creation increases in proportion to the amount of data of the configuration information of the resource to be acquired. Therefore, when the amount of data of the configuration information to be acquired is large, a usage of the CPU increases, the number of simultaneously executable APIs is limited, and the response performance of the configuration information acquisition is deteriorated.

As a technique for reducing an amount of data transmitted when a response to a data file acquisition request is transmitted, there is a technique disclosed in PTL 1. PTL 1 discloses that a response to an acquisition request is generated in which, when the same partial data redundantly appears in a data file in a duplicated manner, the partial data of the data file is included without duplication, and duplicate partial data, which is the partial data that appears in a duplicated manner, and the number of duplicates of the duplicate partial data are notified.

### CITATION LIST

### Patent Literature

PTL 1: JP2017-142664A

### SUMMARY OF THE INVENTION

In the technique of PTL 1, a communication load at the time of transmitting a response is reduced by performing deduplication at the time of acquiring information, but it is not a technique of improving the response performance by reducing a load of a CPU or a memory of a storage. Further, the technique in PTL 1 is a technique of performing the deduplication at the time of acquiring backup data at the time of restoration, and cannot be applied to acquisition of data including unknown contents such as configuration information of a storage.

Therefore, an object of the invention is to provide a technique capable of improving response performance of configuration information acquisition of a storage.

In order to solve the above problems, one of representative storage devices according to the invention is a storage device that acquires configuration information including common data and dynamic data of a plurality of resources, and the storage device includes a processor and a memory. The memory records a hash value of the common data of each of the resources. The processor refers to the hash values of the common data recorded in the memory, groups the plurality of target resources from which the configuration information is to be acquired into groups each having the same hash value of the common data, acquires the common data of the groups, and acquires the dynamic data of the resources.

According to the invention, the response performance of the configuration information acquisition of the storage can be improved.

Problems, configurations, and effects other than those described above will be clarified by the following description of embodiments.

### BRIEF DESCRIPTION OF THE DRAWINGS

FIG. 1 is a block diagram showing an example of a configuration of a storage system according to Embodiment 1;

FIG. 2 is a diagram showing an example of configuration information of resources;

FIG. 3A is a diagram showing information acquisition performed by an API server in the related art;

FIG. 3B is a diagram showing information acquisition performed by an information acquisition efficiency improving service according to the present embodiment;

FIG. 4A is a diagram showing response creation in the related art;

FIG. 4B is a diagram showing response creation performed by the information acquisition efficiency improving service according to the present embodiment;

FIG. 5A is a diagram showing an example of a static data table recorded in a hash value recording database;

FIG. 5B is a diagram showing an example of a changeable data table recorded in the hash value recording database;

FIG. 6 is a sequence diagram showing a flow of a configuration information acquisition process;

FIG. 7 is a flowchart showing an example of the configuration information acquisition process;

FIG. 8 is a sequence diagram showing a flow of an information update process;

FIG. 9A shows a relationship between the number of volumes from which configuration information is to be acquired and a memory usage; and

FIG. 9B shows a relationship between the number of groups and the memory usage.

### DESCRIPTION OF EMBODIMENTS

Hereinafter, an embodiment will be described with reference to the drawings.

### Embodiment 1

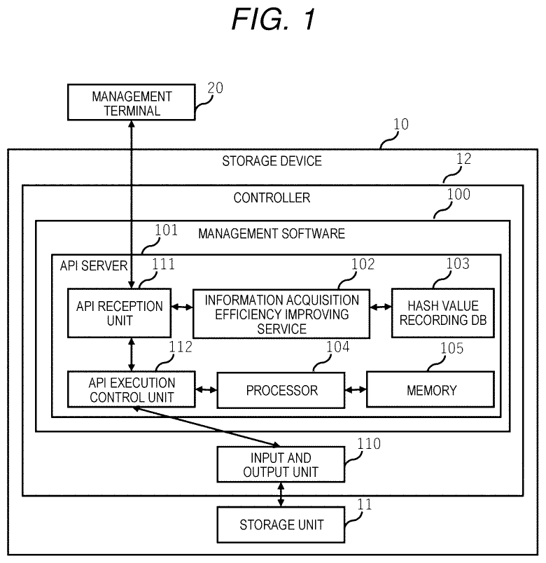

FIG. 1 is a block diagram showing an example of a configuration of a storage system according to Embodiment 1.

The storage system includes a storage device 10 and a management terminal 20. The management terminal 20 is connected to the storage device 10 via a network.

The management terminal 20 executes an application, and issues commands such as Read and Write to the storage device 10. Although not shown, the management terminal 20 includes an interface for connecting to the storage device 10 and a computer including a central processing unit (CPU), a memory, and the like.

Further, the management terminal 20 makes an information acquisition request for requesting configuration information of a resource such as a volume, or a resource configuration change request to the storage device 10.

The storage device 10 includes a storage unit 11 and a controller 12.

The controller 12 performs control of the storage unit 11, an API process from the management terminal 20, data transfer, and the like. The controller 12 executes management software 100 that manages the storage unit 11, and communicates with the storage unit 11 via an input and output unit 110.

An API server 101 included in the management software 100 includes an API reception unit 111 that receives an API from the management terminal 20 and an API execution control unit 112 that executes the API received by the API reception unit 111. The API server 101 is implemented by a processor 104 of the storage device 10 executing a program stored in a memory 105.

The memory 105 is a random access memory (RAM) accessible from the processor 104. When executing request processes of the information acquisition request and the configuration change request, the processor 104 accesses the memory 105 and acquires or updates information held in the memory 105.

The API server 101 executes a request such as the information acquisition request or the configuration change request from the management terminal 20 by the processor 104 accessing the memory 105, and returns an execution result thereof to the management terminal 20.

The storage unit 11 includes one or more drive devices. The storage unit 11 is accessed by the processor 104 via the input and output unit 110. The drive device includes a hard disk drive (HDD) using a storage medium such as a magnetic disk, a solid state drive (SSD) using a storage medium such as a flash memory.

The configuration information is, for example, information related to resources of the storage device 10, such as a volume capacity, a drive device ID, and a type.

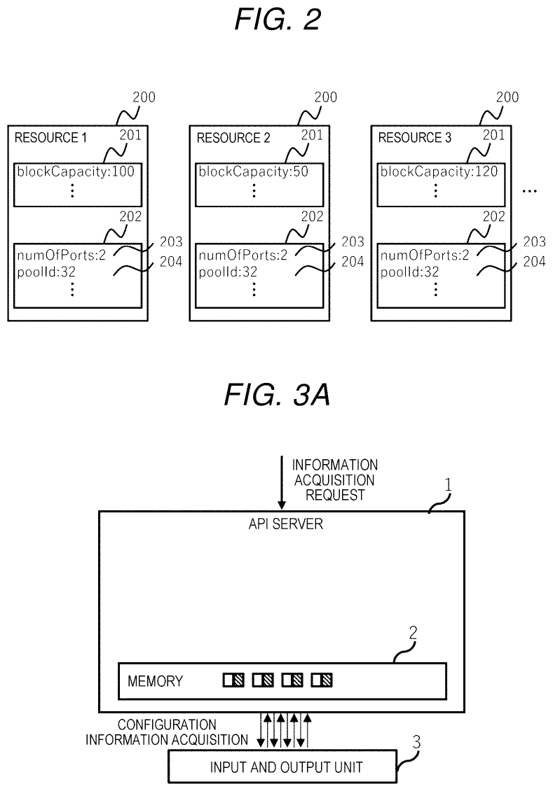

Here, the configuration information of the resource acquired by the API server 101 from the controller 12 in response to the information acquisition request from the management terminal 20 will be described with reference to FIG. 2.

FIG. 2 is a diagram an example of the configuration information of the resources.

When receiving the information acquisition request from the management terminal 20, the API server 101 acquires configuration information 200 of each resource from the input and output unit 110.

The configuration information 200 of each resource includes dynamic data 201 and common data 202. A parameter set for each piece of data is fixed for each resource type. The dynamic data 201 and the common data 202 are set as follows.

The dynamic data 201 is a parameter that is dynamically changed according to a usage status of each resource, such as a block capacity.

The common data 202 is data commonly existing in the configuration information 200 of each resource. As described above, since the parameter set in the configuration information 200 is fixed for each resource type, when a large number of resources of the same resource type are created, these resources may have a common parameter (common data 202).

The common data 202 includes static data 203 and changeable data 204.

The static data 203 is data that is set during resource creation, such as a port number, and is not changed by a configuration change or a setting change after the creation.

The changeable data 204 is data such as a pool ID that is changed by the configuration change or the setting change after the resource creation.

Returning to FIG. 1, the API server 101 includes an information acquisition efficiency improving service 102 and a hash value recording database 103.

The information acquisition efficiency improving service 102 is implemented by the processor 104 executing a program held in the memory 105. The hash value recording database 103 is held in the memory 105.

The information acquisition efficiency improving service 102 analyzes the configuration information 200 of the resource acquired from the input and output unit 110, and determines whether the common data 202 common to the configuration information of the plurality of resources exists.

When the common data 202 exists, the information acquisition efficiency improving service 102 creates a hash value of the common data 202 and records a data table in which the hash value and a path of the resource are associated with each other in the hash value recording database 103. By creating the hash value, an amount of data held in the memory 105 can be reduced and the common data can be recorded.

In addition, the information acquisition efficiency improving service 102 analyzes the API of the information acquisition request of the management terminal 20, acquires only one piece of common data 202 for resources having the same hash value with reference to the hash value recording database 103, and acquires the dynamic data 201 of each resource.

The information acquisition efficiency improving service 102 integrates the acquired dynamic data 201 and common data 202 to create a response to the management terminal 20.

When the information on the resource for which the configuration information is acquired is not recorded in the hash value recording 103, database the information acquisition efficiency improving service 102 creates a hash value of the common data 202 of the resource and records the hash value in the hash value recording database 103.

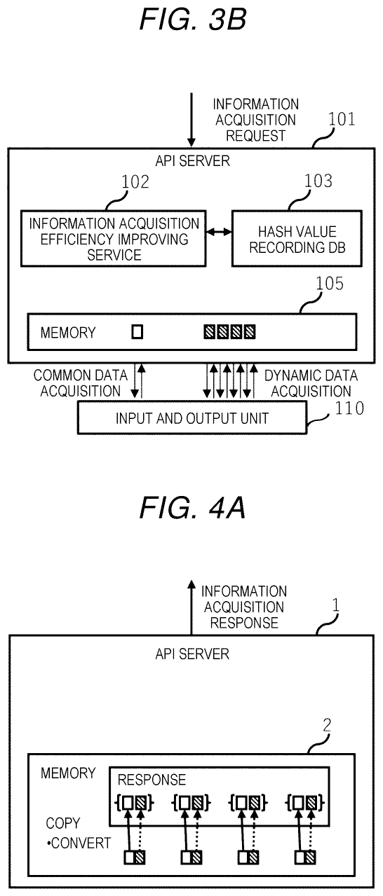

Next, an effect of reducing memory usage in the configuration information acquisition performed by the information acquisition efficiency improving service 102 according to the present embodiment will be described with reference to FIGS. 3A and 3B.

FIG. 3A is a diagram showing information acquisition by an API server in the related art.

An API server 1 in the related art acquires the configuration information 200 of the plurality of resources of the storage device from an input and output unit 3 and holds the configuration information 200 in a memory 2. The configuration information 200 of each resource acquired here includes the common data 202 and the dynamic data 201.

FIG. 3B is a diagram showing the information acquisition by the information acquisition efficiency improving service 102 according to the present embodiment.

The API server 101 according to the present embodiment includes the information acquisition efficiency improving service 102. The information acquisition efficiency improving service 102 analyzes the APIs of the information acquisition requests of the plurality of resources from the management terminal 20, collates an analysis result with the hash value recording database 103, and identifies the dynamic data 201 and the common data 202 contained in the acquired configuration information 200.

Thereafter, the information acquisition efficiency improving service 102 acquires the dynamic data 201 of each resource from the input and output unit 110, acquires only one piece of the common data 202 for the resource having the same common data 202, and holds the common data 202 in the memory 105.

According to the present embodiment, the information acquisition efficiency improving service 102 does not hold a plurality of pieces of the same common data 202 in the memory 105, and the memory usage of the storage device can be reduced.

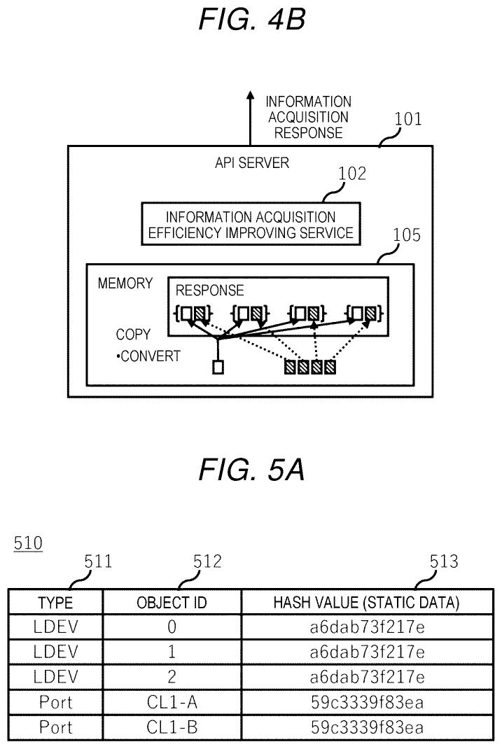

Next, an effect of reducing CPU usage in response creation performed by the information acquisition efficiency improving service 102 according to the present embodiment will be described with reference to FIGS. 4A and 4B.

FIG. 4A is a diagram showing response creation in the related art.

In the API server in the related art, a processor (not shown) creates a response to the management terminal 20 by copying and converting the configuration information 200 held in the memory 2 into a form suitable for the response. The configuration information 200 to be copied and converted here includes the common data 202 and the dynamic data 201.

FIG. 4B is a diagram showing the response creation performed by the information acquisition efficiency improving service 102 according to the present embodiment.

In the API server 101 according to the present embodiment, the processor 104 copies and converts the common data 202 and the dynamic data 201 held in the memory 105 into a form suitable for the response, and then integrates the data to create the response to the management terminal 20. At this time, the copy and conversion process of the same common data is performed only once.

According to the present embodiment, the information acquisition efficiency improving service 102 eliminates a need for the processor 104 to copy and convert the same common data 202 many times, thereby reducing the CPU usage of the storage device.

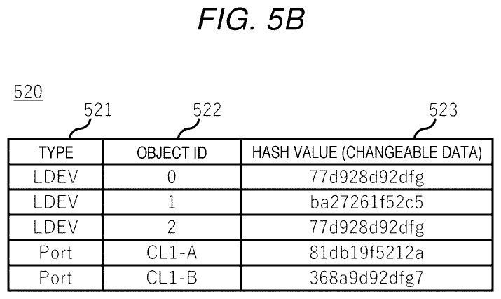

Next, a data table in which the hash values recorded in the hash value recording database 103 are associated with the paths of the resources will be described with reference to FIG. 5.

FIG. 5A is a diagram showing an example of a static data table recorded in the hash value recording database 103. In a static data table 510, a hash value 513 of the static data 203 is recorded in association with a resource type 511 and an object ID 512 which are paths for specifying the resource of the configuration information 200.

FIG. 5B is a diagram showing an example of the changeable data table recorded in the hash value recording database 103.

In a changeable data table 520, a hash value 523 of the changeable data 204 is recorded in association with a resource type 521 and an object ID 522 which are paths for specifying the resource of the configuration information 200.

The information acquisition request from the management terminal 20 includes a resource type and an object ID for specifying a resource from which the configuration information is to be acquired. The information acquisition efficiency improving service 102 refers to the hash values 513, 523 and classifies the resource specified by the information acquisition request into a group having the same hash value.

For the common data 202 of the resource having the same hash values 513, 523, the static data 203 or the changeable data 204 is acquired from only one resource.

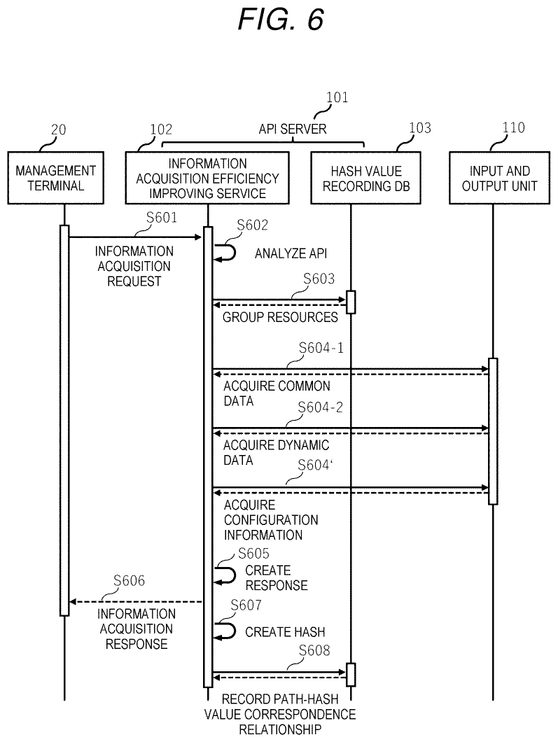

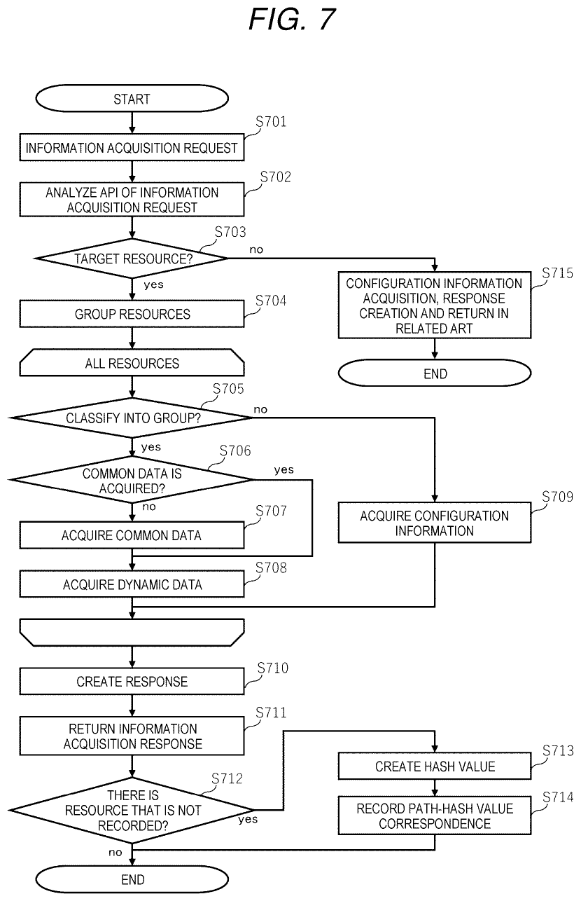

Next, a configuration information acquisition process performed by the information acquisition efficiency improving service 102 according to the present embodiment will be described with reference to FIGS. 6 and 7. This process is a process of acquiring the configuration information of the resource in response to an information acquisition request from the management terminal 20, and creating and returning a response to the management terminal 20. This process is implemented by the processor 104 of the storage device 10 executing a program stored in the memory 105.

FIG. 6 is a sequence diagram showing a flow of the configuration information acquisition process.

First, the information acquisition efficiency improving service 102 receives an API of an information acquisition request from the management terminal 20 (step S601).

Next, the information acquisition efficiency improving service 102 analyzes the API of the information acquisition request, and specifies the target resource from which the configuration information is to be acquired, based on the resource type and the object ID contained in the information acquisition request (step S602).

Next, the information acquisition efficiency improving service 102 collates the resource type and the object ID contained in the information acquisition request with the hash value recording database 103, and groups resources having the same hash value as the same group (step S603).

As a result of the grouping in step S603, for the resources classified into groups, the information acquisition efficiency improving service 102 acquires the common data 202 (static data 203 and changeable data 204) of the same group from the input and output unit 110 only once (step S604-1), and acquires the dynamic data 201 of each resource from the input and output unit 110 (step S604-2).

As a result of the grouping in step S603, for the resources not classified into groups, the information acquisition efficiency improving service 102 acquires all the configuration information including the common data 202 and the dynamic data 201 from the input and output unit 110 (step S604′).

Next, the information acquisition efficiency improving service 102 copies and converts the acquired configuration information, creates the response to the management terminal 20 (step S605), and returns the created response to the management terminal 20 (step S606). When the common data 202 and the dynamic data 201 are acquired, the information acquisition efficiency improving service 102 copies and converts the common data 202 and the dynamic data 201 and then integrates the data to create the response to the management terminal 20.

When the resources from which the configuration information is acquired include a resource in which the hash value of the common data 202 is not recorded in the hash value recording database 103, the information acquisition efficiency improving service 102 creates a hash value of the common data 202 of the static data 203 and the changeable data 204 of the resource (step S607), records the created hash value of the common data 202 in the hash value recording database 103 in association with the path of the resource (step S608), and ends the process.

FIG. 7 is a flowchart showing an example of the configuration information acquisition process.

The information acquisition efficiency improving service 102 receives the API of the information acquisition request from the management terminal 20 (step S701).

Next, the information acquisition efficiency improving service 102 analyzes the API of the information acquisition request (step S702). Here, the target resource from which the configuration information is to be acquired is specified based on the resource type and the object ID contained in the information acquisition request acquired in step S701.

Next, based on the resource type, the information acquisition efficiency improving service 102 determines whether the resource specified in step S702 is a target resource for which information acquisition efficiency improvement according to the present embodiment is performed (step S703). Depending on the resource type, there may be no common data 202 or there may be only one resource, and such a resource type is not a target of the present embodiment.

When the target resource from which the configuration information is to be acquired is not the target for which the information acquisition efficiency improvement according to the present embodiment is performed (NO in step S703), the information acquisition efficiency improving service 102 acquires the configuration information and creates and returns a response by a method in the related art as shown in FIGS. 3A and 4A (step S715), and ends the present process. That is, the information acquisition efficiency improving service 102 acquires the configuration information including the dynamic data 201 and the common data 202 of all resources from the input and output unit 110.

On the other hand, when the target resource from which the configuration information is to be acquired is the target for which the information acquisition efficiency improvement according to the present embodiment is performed (YES in step S703), the information acquisition efficiency improving service 102 collates the resource type and the object ID contained in the information acquisition request with the hash value recording database 103, and groups the resources having the same hash value as the same group (step S704). The result of the grouping is held in the memory 105 until the creation of the response is completed.

Hereinafter, an example of acquiring configuration information of 16834 volumes having object IDs of 0 to 16833 will be described.

For example, when the hash values 513 of the static data 203 of the volumes whose object IDs are 0 to 15000 are the same, these volumes are classified into one group (first group).

When the hash values 523 of the changeable data 204 of the volumes having the object IDs of 0 to 7000, the volumes having the object IDs of 7001 to 10000, and the volumes having the object IDs of 10001 to 15000 are the same, these volumes are classified into respective groups (second groups).

In addition, when there is no resource having the same hash value in the volumes whose object IDs are 15001 to 16833, these volumes are not classified into groups.

Next, the information acquisition efficiency improving service 102 repeatedly executes the processes of steps S705 to S709 until the processes are completed for all the resources from which the configuration information is to be acquired.

First, the information acquisition efficiency improving service 102 determines whether the resources are classified into groups as the result of the grouping in step S705 (step S705).

When the resources are not classified into groups (NO in step S705), all configuration information including the common data 202 and the dynamic data 201 of the resources is acquired from the input and output unit 110 (step S709).

On the other hand, when the resources are classified into groups (YES in step S705), the information acquisition efficiency improving service 102 determines whether the common data 202 (static data 203 and changeable data 204) of the groups (first group and second group) into which the resources are classified is acquired (step S706).

When at least one of the static data 203 and the changeable data 204 of the group into which the resources are classified is not acquired (NO in step S706), the common data 202 that is not acquired is acquired from the input and output unit 110 (step S707), and the process proceeds to step S708.

On the other hand, when the common data 202 (static data 203 and changeable data 204) of the resource is acquired (NO in step S706), the process proceeds to step S708 without executing step S707.

Next, the information acquisition efficiency improving service 102 acquires the dynamic data 201 of the resource from the input and output unit 110 (step S708).

When the processes of steps S705 to S709 are completed for all the resources from which the configuration information is to be acquired, the information acquisition efficiency improving service 102 copies and converts the acquired configuration information and creates a response to the management terminal 20 (step S710). When the common data 202 and the dynamic data 201 are acquired in steps S707 to S708, the information acquisition efficiency improving service 102 copies and converts the common data 202 and the dynamic data 201 and then integrates the data to create the response to the management terminal 20.

Next, the response created in step S710 is returned to the management terminal 20 (step S711).

Next, it is determined whether there is a resource in which the hash value of the common data 202 is not recorded in the hash value recording database 103 among the resources from which configuration information is acquired in steps S705 to S709 (step S712).

When there is no resource in which the hash value of the common data 202 is not recorded in the hash value recording database 103 among the resources from which the configuration information is acquired in steps S705 to S709 (NO in step S712), the present process ends.

When there is a resource in which the hash value of the common data 202 is not recorded in the hash value recording database 103 among the resources from which the configuration information is acquired in steps S705 to S709 (YES in step S712), the hash value of the common data 202 (static data 203 and changeable data 204) of the resource is created (step S713).

Next, the information acquisition efficiency improving service 102 records the hash value of the common data 202 created in step S713 in the hash value recording database 103 in association with the path of the resource (step S714), and ends the process.

According to the configuration information acquisition process in FIG. 7, since the information acquisition efficiency improving service 102 groups the resources having the same hash value of the common data 202 into the same group and acquires the common data 202 of the group only once, it is possible to reduce loads of the processor 104 and the memory 105 of the storage device 10 and improve response performance of the configuration information acquisition of the storage.

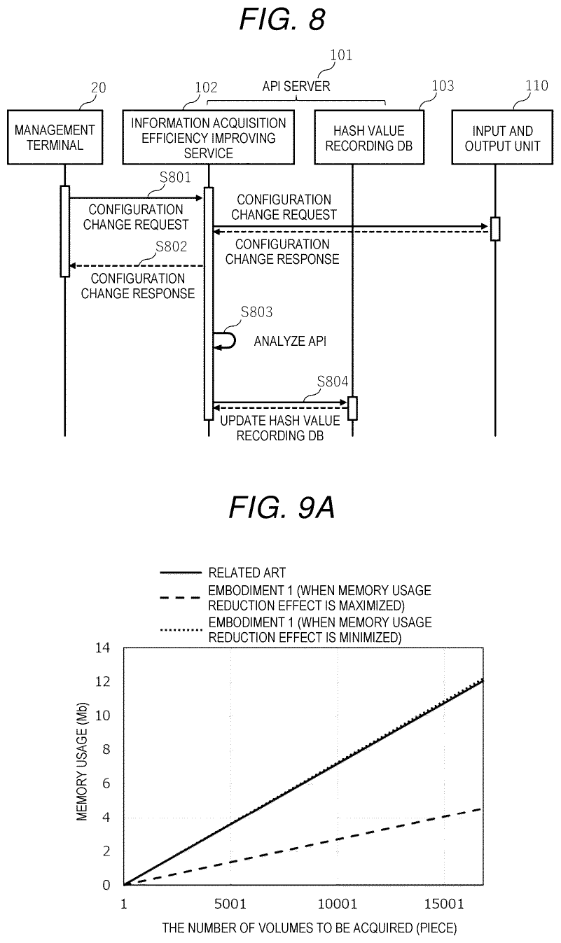

Next, an information update process performed by the information acquisition efficiency improving service 102 according to the present embodiment will be described with reference to FIG. 8. This process is a process of updating the information recorded in the hash value recording database 103 when the configuration change of the resource is performed. This process is implemented by the processor 104 of the storage device 10 executing a program held in the memory 105.

FIG. 8 is a sequence diagram showing a flow of the information update process.

First, the information acquisition efficiency improving service 102 receives the API of the configuration change request from the management terminal 20, transmits the configuration change request to the input and output unit 110, and performs the configuration change of the resource (step S801).

Next, the information acquisition efficiency improving service 102 receives an API of a configuration change response from the input and output unit 110 (step S802), and returns the configuration change response to the management terminal 20.

Next, the information acquisition efficiency improving service 102 analyzes the API of the configuration change request, specifies the target resource to be subjected to the configuration change, analyzes the API of the configuration change response from the input and output unit 110, and specifies the performed configuration change (step S803).

Next, the information acquisition efficiency improving service 102 updates the hash value recording database based on the analysis result of step S803 (step S804), and ends the process.

For example, when the changeable data 204 is changed as a result of the analysis in step S803, a hash value of the changeable data 204 after the change is created and recorded in the hash value recording database 103.

In addition, when a change for deleting the target resource is made as a result of the analysis in step S803, the information of the target resource is deleted from the hash value recording database 103.

According to the information update process of FIG. 8, when the configuration change of the resource is performed, the information recorded in the hash value recording database 103 can be updated.

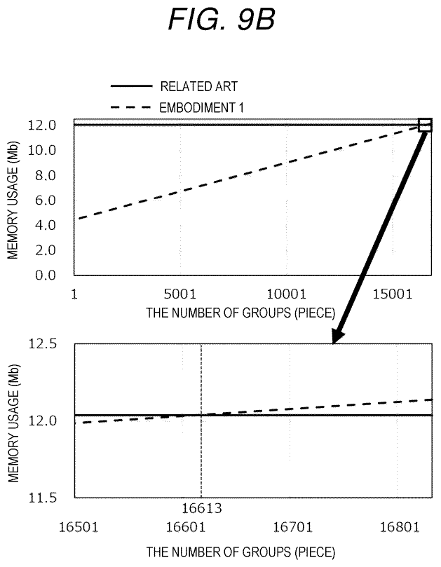

Next, the effect of reducing the memory usage of the information acquisition efficiency improving service 102 according to the present embodiment will be described with reference to FIGS. 9A and 9B. Hereinafter, a case of acquiring configuration information of a volume will be described as an example.

FIG. 9A shows a relationship between the number of volumes from which configuration information is to be acquired and the memory usage.

The API server 1 in the related art acquires all configuration information including the common data 202 and the dynamic data 201 of each volume. Therefore, assuming that the configuration information of each volume is 715 bytes, the memory usage is expressed by the following equation.

$$715 ( byte ) \times the number of volumes ( piece )$$

On the other hand, the API server 101 having the information acquisition efficiency improving service 102 according to the present embodiment acquires only one piece of the same common data 202. Therefore, assuming that the common data 202 of each volume is 452 bytes, the dynamic data 201 is 263 bytes, and the object ID is 6 bytes, the memory usage is expressed by the following equation.

$$452 ( byte ) \times the number of common data ( piece ) + 263 ( byte ) + 6 ( byte ) ) \times the number of volumes ( piece )$$

The object IDs are the object IDs held in the memory 105 and grouped in step S704 of FIG. 7.

FIG. 9B shows a relationship between the number of groups and the memory usage.

When the number of groups of the common data 202 grouped in step S704 of FIG. 7 is small, the number of pieces of the common data 202 to be acquired is small, and thus the effect of reducing the memory usage is improved. On the other hand, when the number of groups of the common data 202 is large, the number of pieces of common data 202 to be acquired is large, and thus the effect of reducing the memory usage is reduced.

Therefore, when the configuration information of all the resources includes the same common data 202, the effect of reducing the memory usage is maximized. On the other hand, when the configuration information of all the resources has different common data 202, the effect of reducing the memory usage is minimized.

According to the present embodiment, as shown in FIGS. 9A and 9B, the memory usage can be reduced in most cases.

The processor 104 copies the configuration information acquired from the input and output unit 110 and converts the configuration information into a form suitable for the response. In the present embodiment, the number of times of converting the configuration information can be reduced, and a CPU load can be reduced.

An example of acquiring 16834 volumes will be described below. It is assumed that 20 items of data are acquired for each volume.

The API server 1 in the related art converts the configuration information including the common data 202 and the dynamic data 201 of each volume. Therefore, the number of data to be converted into a form suitable for the response by the processor 104 is 336680 according to the following equation.

$$20 ( item ) \times 16834 ( piece ) = 336680 ( piece )$$

On the other hand, the API server 101 having the information acquisition efficiency improving service 102 according to the present embodiment converts the same common data 202 only once. Assuming that the common data 202 of each volume is of 11 items and the dynamic data 201 is of 9 items, the number of pieces of data to be converted into a form suitable for the response by the processor 104 is 151517 according to the following equation.

$$11 ( item ) + 9 ( item ) \times 16834 ( piece ) = 151517 ( piece )$$

As described above, according to the present embodiment, the CPU usage can be reduced by reducing the data to be copied and converted.

Further, in the storage, the common data 202 of the resource includes data (changeable data 204) changed by the configuration change and data (static data 203) not changed by the configuration change. Since the static data 203 has variations less than that of the changeable data 204, it is possible to obtain a higher memory usage reduction effect by separating the static data 203 and the changeable data 204. An example of the reduction effect obtained by separating the static data 203 and the changeable data 204 will be described below.

When the static data 203 and the changeable data 204 are not separated, if it is assumed that the number of volumes is 16834, the common data 202 is 452 bytes, the dynamic data 201 is 263 bytes, the number of groups of the common data 202 is 1000, and the object ID is 6 bytes, the memory usage is 4,980,346 bytes according to the following equation.

$$452 ( byte ) \times 1000 ( piece ) + ( 263 ( byte ) + 6 ( byte ) ) \times 16834 ( piece ) = 4 , 980 , 346$$

On the other hand, when the static data 203 and the changeable data 204 are separated, if it is assumed that the number of volumes is 16834, the changeable data 204 is 213 bytes, the static data 203 is 239 bytes, the dynamic data 201 is 263 bytes, the number of groups of the changeable data 204 is 1000, the number of groups of the static data 203 is 10, and the object ID is 6 bytes, the memory usage is 4,742,736 bytes according to the following equation.

$$213 ( byte ) \times 1000 ( piece ) + 239 ( byte ) \times 10 ( piece ) + ( 263 ( byte ) + 6 ( byte ) ) \times 16834 ( piece ) = 4 , 980 , 346$$

As described above, according to the present embodiment, by separating the static data 203 and the changeable data 204, it is possible to obtain a higher memory usage reduction effect.

According to the present embodiment, it is possible to reduce the loads on the CPU and the memory of the storage and improve the response performance of the configuration information acquisition of the storage.

In addition, power consumption in the storage can be reduced by reducing a usage of the CPU and the memory. Therefore, it is possible to reduce a CO2 emission amount and contribute to the environment.

The invention is not limited to the embodiment described above, and includes various modifications. For example, the embodiment described above has been described in detail to facilitate understanding of the invention, and the invention is not necessarily limited to those including all the configurations described above.

What is claimed is:

1. A storage device that acquires configuration information including common data and dynamic data of a plurality of resources, the storage device comprising:
a processor; and
a memory, wherein
the memory records a hash value of the common data of each of the resources, and
the processor
refers to the hash values of the common data recorded in the memory,
groups the plurality of target resources from which the configuration information is to be acquired into groups each having the same hash value of the common data,
acquires the common data of the groups, and
acquires the dynamic data of the resources.

2. The storage device according to claim 1, wherein
the processor
acquires the common data and the dynamic data in response to a request from a management terminal,
creates a response by integrating the acquired common data and dynamic data after converting the acquired common data and dynamic data into a form suitable for the response, and
returns the created response to the management terminal.

3. The storage device according to claim 2, wherein
when the hash value of the acquired common data is not recorded in the memory, the processor creates a hash value of the common data and records the created hash value in the memory.

4. The storage device according to claim 2, wherein
the common data includes changeable data which is changed by a configuration change and static data which is not changed by the configuration change,
the memory records a hash value of the changeable data of each of the resources and a hash value of the static data of each of the resources, and
the processor
refers to the hash values of the changeable data recorded in the memory to group a target resource from which the configuration information is to be acquired into a first group having the same hash value of the changeable data,
refers to the hash values of the static data recorded in the memory to group a target resource from which the configuration information is to be acquired into a second group having the same hash value of the static data, and
acquires the changeable data of the first group and the static data of the second group.

5. The storage device according to claim 4, wherein
when the changeable data is changed, the processor creates a hash value of the changeable data after the change and records the created hash value in the memory.

6. A control method of a storage device that acquires configuration information including common data and dynamic data of a plurality of resources, the storage device including a processor and a memory, the control method comprising:
recording, by the memory, a hash value of the common data of each of the resources;
referring to, by the processor, the hash values of the common data recorded in the memory;
grouping, by the processor, the plurality of target resources from which the configuration information is to be acquired into groups each having the same hash value of the common data;
acquiring, by the processor, the common data of the groups; and
acquiring, by the processor, the dynamic data of the resources.
